(19) United States
(12) Patent Application Publication
(10) Pub. No.: US 2015/0285507 A1
(43) Pub. Date: Oct. 8, 2015

(54) Reduced Smoke Outdoor Fire Burner

(71) Applicant: Dan Troyer, JR., Applecreek, OH (US)

(72) Inventor: Dan Troyer, JR., Applecreek, OH (US)

(21) Appl. No.: 14/681,685

(22) Filed: Apr. 8, 2015

Related U.S. Application Data
(60) Provisional application No. 61/976,639, filed on Apr. 8, 2014.

(51) Int. Cl. F24B 1/182; F24B 1/19; A47J 33/00

(52) U.S. Cl. CPC F24B 1/182; A47J 33/00; F24B 1/1902

(57) ABSTRACT

A device for containing a camp fire reduces the amount of smoke produced by the fire. The device reduces the amount of smoke by supplying air to the top of the fire to increase the combustion and thus reduce the smoke produced. In one configuration of the device, the air supplied to the top of the tire is heated prior to being introduced to the top of the fire. The disclosure also provides a configuration wherein the preheating of the air simultaneously cools the outer surface of the device.

### CROSS REFERENCE TO RELATED APPLICATIONS

This application claims the benefit of U.S. Provisional Patent Application Ser. No. 61/976,639 filed Apr. 8, 2014; the disclosures of which are incorporated herein by reference.

### BACKGROUND OF THE INVENTION

1. Technical Field

The invention generally relates to devices used to contain fires and, more particularly, to an outdoor fire containment device commonly known as a fire pit. Specifically, the invention relates to a fire pit configured to reduce the amount of smoke produced from the fire burning in the device.

2. Background Information

People enjoy burning small camp fires in their backyards. These fires are used for general enjoyment and for cooking. One drawback with a backyard campfire—especially one made from a soft wood or a wood containing water—is the smoke generated from the fire. The smoke can infiltrate the owner's house and neighbors' houses. This problem has led some cities and communities to completely ban backyard campfires. Some people use fire pits to control and contain their camp fires. In some communities, the use of a fire ring or fire pit is mandatory. A problem with some fire pits is that parts of them become hot and are thus dangerous to those who unexpectedly contact the hot elements of the fire pit.

### SUMMARY OF THE DISCLOSURE

The disclosure provides a device for containing a camp fire that reduces the amount of smoke produced by the fire. The device reduces the amount of smoke by supplying air to the top of the fire to increase the combustion and thus reduce the smoke produced. In one configuration of the device, the air supplied to the top of the fire is heated prior to being introduced to the top of the fire.

The disclosure also provides a configuration wherein the preheating of the air simultaneously cools the outer surface of the device.

The disclosure provides the body of the device in the shape of right-cylinder with a generally closed-off bottom wall and an upper lip that overhangs the sidewall. The diameter of the device is about twice the height. Combustion air is provided to the fire under the overhanging lip. This configuration has been found to reduce the amount of smoke produced by a fire burning in the device.

The disclosure provides one configuration having a double sidewall design such that the two concentric spaced sidewalls define the air flow passage for introducing the combustion air to the top of the fire. This air flow passage is disposed essentially continuously about the circumference of the device. Another configuration uses a plurality of individual passages to deliver the air.

A grilling screen may be used directly on top of the device or held over the device by a stand.

The body of the device is supported by a plurality of legs to allow air to be drawn into the device from the bottom wall of the device. Shields are used on the inside of the bottom wall of the bottom to prevent these holes from directly clogging and to prevent ashes to fall out of the device through the holes.

The disclosure also provides a combustion chamber having a width designed relative to its height such that air supplied to the top of the fire is able to reach the center of the fire for good combustion. An overhanging lip is used to direct the air radially inwardly.

The individual features may be combined in different combinations than specifically described below to form different configurations of the device of the disclosure.

### BRIEF DESCRIPTION OF THE DRAWINGS

FIG. 1 is a perspective view of an exemplary configuration of the smokeless outdoor fire pit.

FIG. 2 is a section view taken along line 2-2 of FIG. 1.

FIG. 3 is a section view taken along line 3-3 of FIG. 1.

FIG. 4 is a section view taken along line 4-4 of FIG. 1.

FIG. 5 is a front view of the fire pit of FIG. 1.

FIG. 6 is a right side elevation view of FIG. 5.

FIG. 7 is a left side elevation view of FIG. 5.

FIG. 8 is a rear elevation view of FIG. 5.

FIG. 9 is a top plan view of FIG. 5.

FIG. 10 is a bottom plan view of FIG. 5.

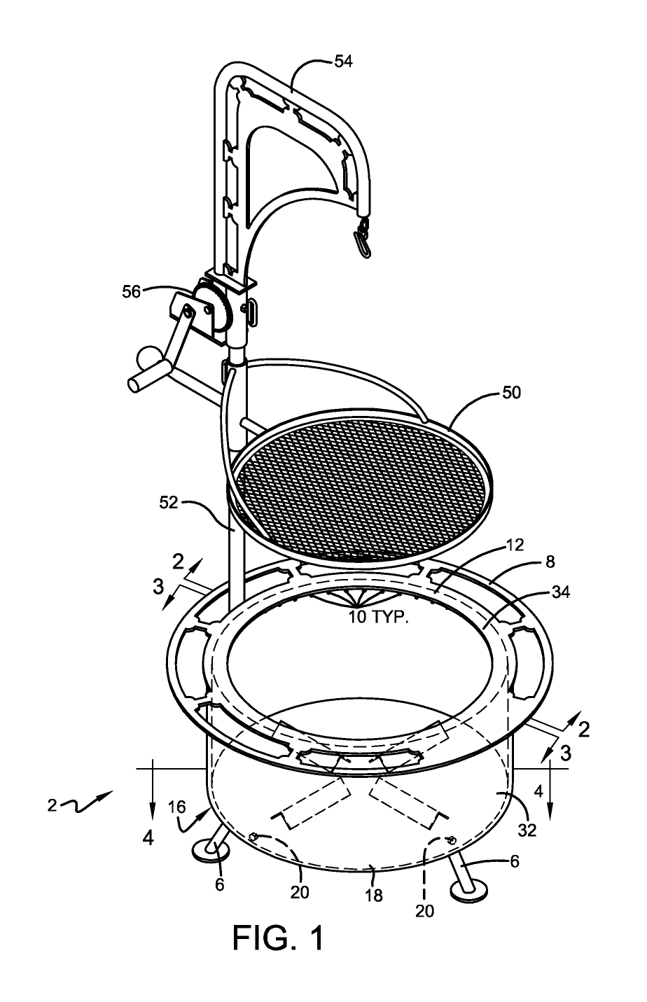

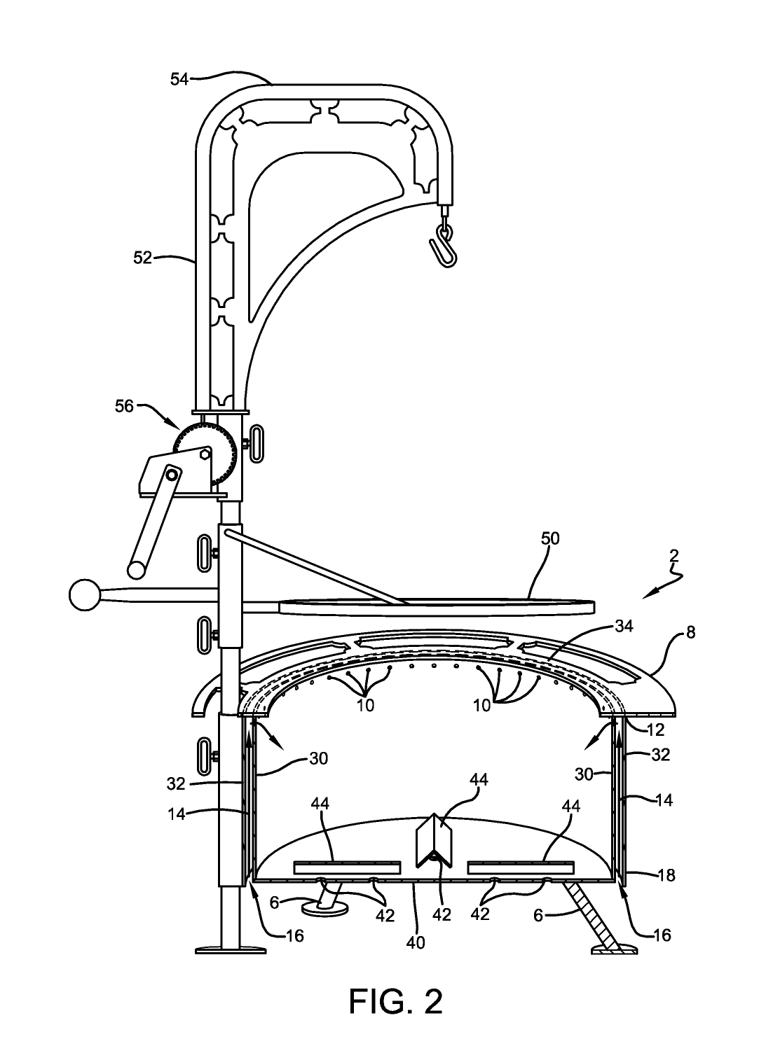

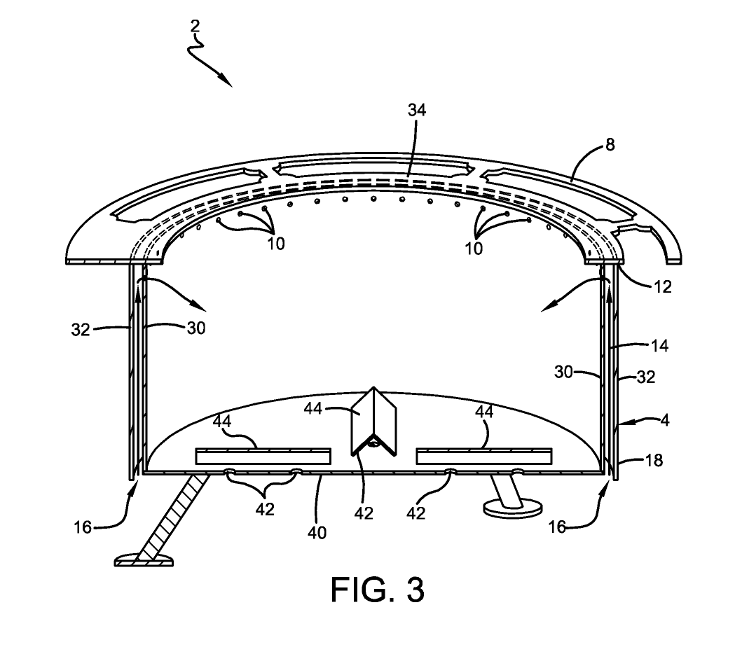

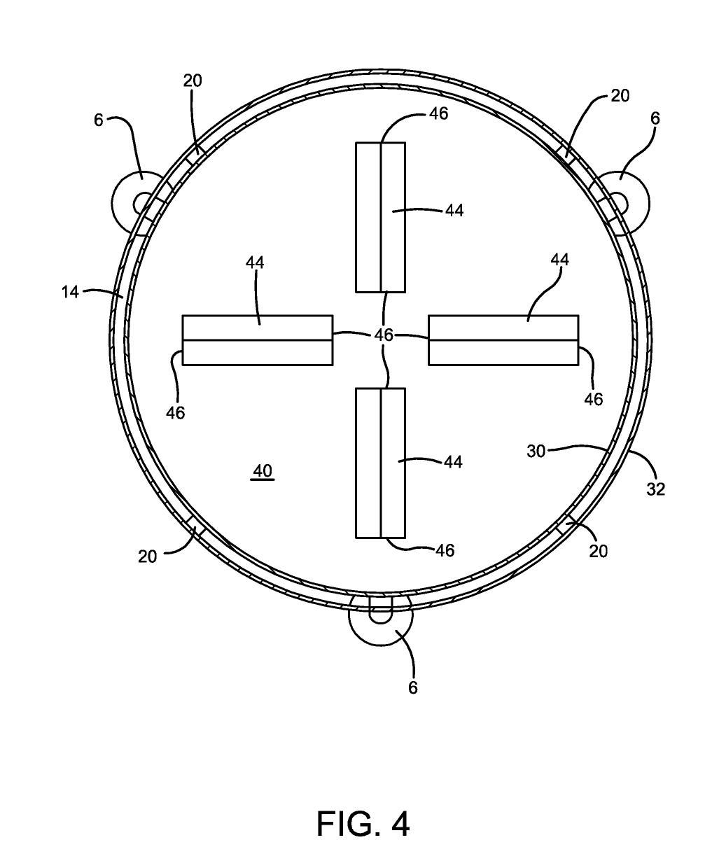

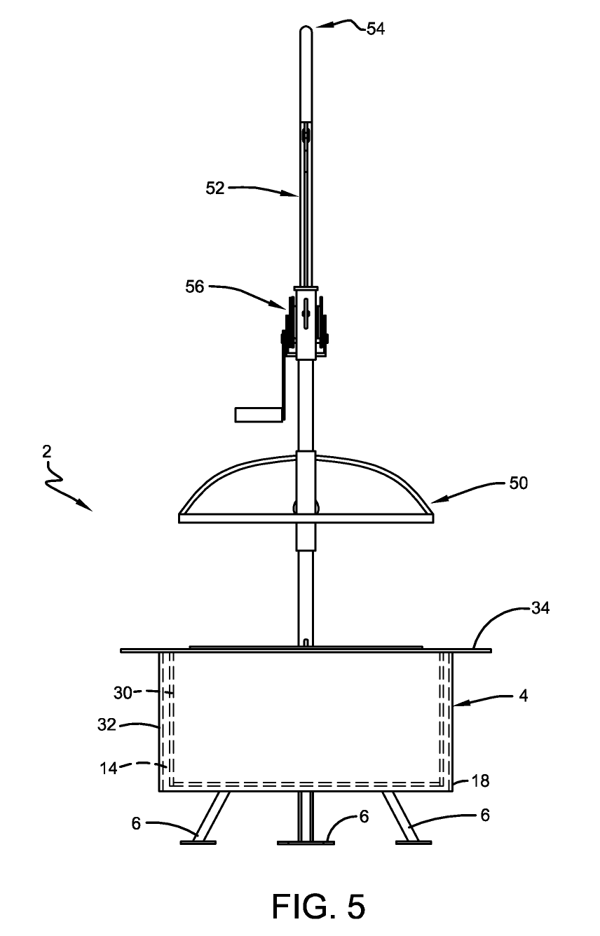

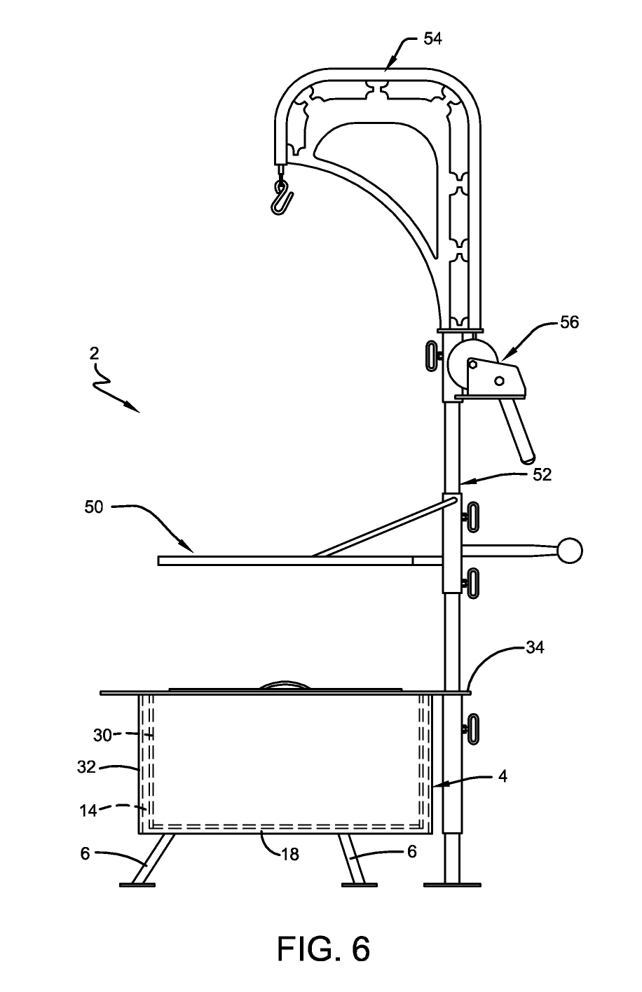

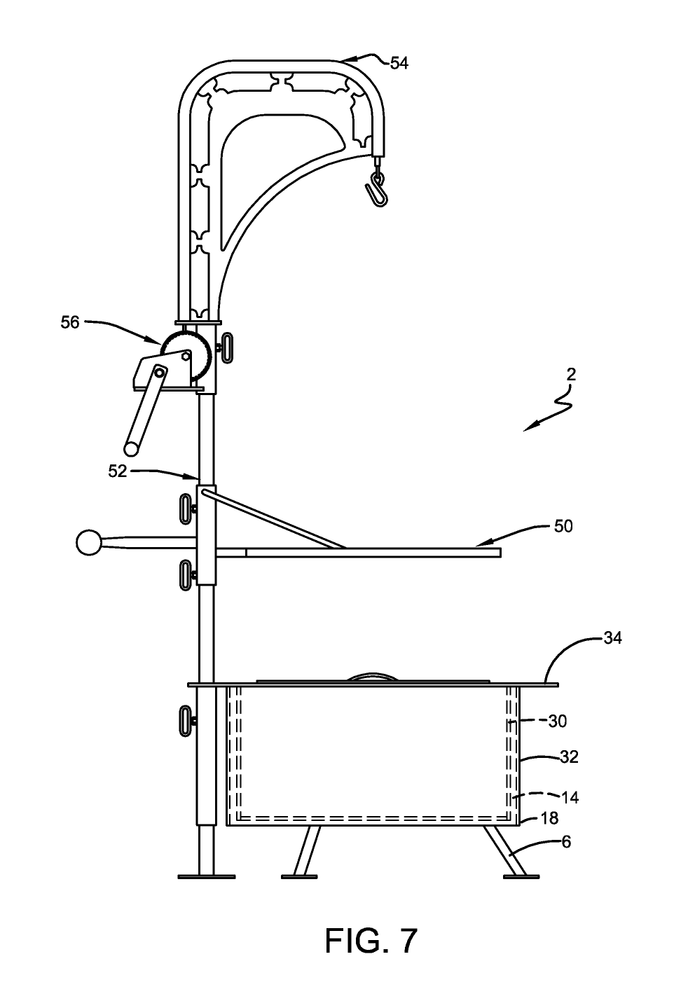

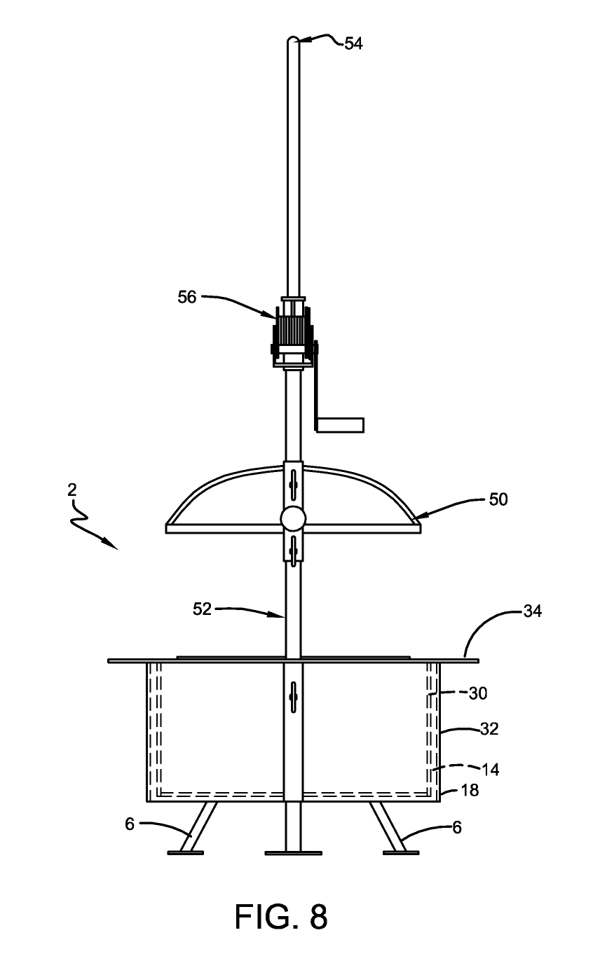

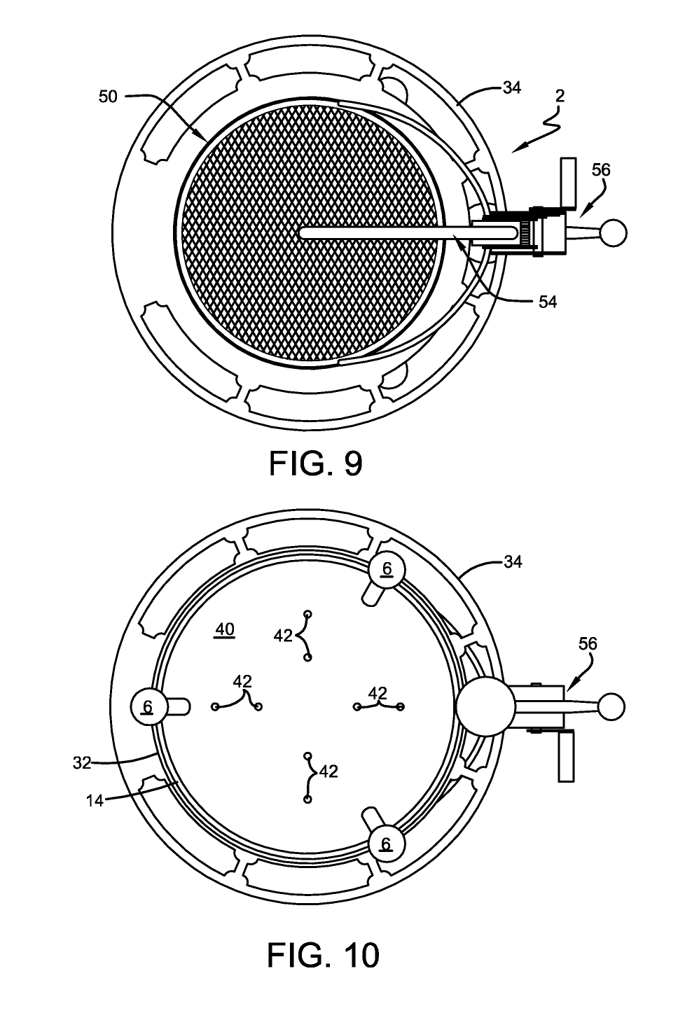

Similar numbers refer to similar parts throughout the specification.

### DETAILED DESCRIPTION OF THE INVENTION

An exemplary configuration of fire pit device of the disclosure is indicated generally by the numeral 2 in the accompany drawings. Device 2 generally includes a main body 4 supported above the ground by a plurality of legs 6. A rim 8 is disposed about the top of main body 4. Rim 8 may be used to support cooking tools, grills, or as a protective bumper. Device 2 provides a safe and convenient place for one to burn a small fire that can be used for cooking or general enjoyment. The fire is burned in the cavity defined by main body 4. Device 4 may be made from any of a variety of fire-resistance materials. Main body 4 may be fabricated from steel and protected with a heat-resistant paint.

One feature of device 2 is that it is configured to reduce the amount of smoke produced by the fire burning in main body 4. The reduction in smoke is achieved by supplying heated combustion air to the top of the fire. This air is supplied through a plurality of upper air supply openings 10 defined by main body 4 adjacent the upper end 12 of main body 4. Openings 10 may extend about the entire circumference of body 4. Openings 10 may be evenly spaced. Air is supplied to upper air supply openings 10 through an air supply duct 14 that extends from an inlet 16 disposed adjacent the lower end 18 of main body 4 to openings 10. In one configuration of device 2, air supply duct 14 is disposed about the entire circumference of main body 4 with only a plurality of supports 20 interrupting the air flow through duct 14. Supports 20 are disposed closer to lower end 18 than upper end 12. In another configuration, duct 14 may be divided into a plurality of adjacent or spaced ducts. Positioning air duct 14 along the sidewall of main body 4 allows the air flowing up through duct 14 to be heated before it exits duct 14 to aid the combustion.

In the exemplary configuration, duct 14 is defined by inner 30 and outer 32 concentric sidewalls of body 4. The lower ends of sidewalls 30 and 32 are spaced and not connected to define inlet 16. The upper ends of sidewalls 30 and 32 are joined together by a cap 34 so that all openings 10 define the outlet of duct 14. In another configuration, the lower ends of walls 30 and 2 are joined and a plurality of inlets 16 are defined. When a fire is burning in main body 4, inner sidewall 30 is heated to draw air into inlet 16 where it is warmed. The warmed air rises within duct 14 and exits through openings 10 to the top of the fire. Cap 34 projects radially inwardly over the openings 10 to form a lip that helps to direct air from openings 10 toward the middle of the fire. The warmed air assists the combustion and thus reduces the amount of smoke produced by the fire. In situations where the fire is producing an undesirable amount of smoke, adding fuel to the fire is suggested in order to increase the amount of heat available to warm the air in duct 14. The spaced sidewalls 30 and 32 and the process of drawing cool air between the walls where it is warmed reduces the temperature of outer sidewall 32. In some situations, outer sidewall 32 may be touched by the hand without danger even while inner sidewall 30 is too hot to touch without pain.

Main body 4 is provided in the form of a cylindrical cup with inner sidewall 30 forming a right angle with the bottom wall 40 of main body 4. The height of main body 4 is about half of the diameter with the lip formed by cap 34 extending inwardly about a half inch to three inches. In one configuration, the height of main body 4 is one foot with the diameter being two feet. These dimensions have been found to provide desirable results with the air supplied through openings 10 being radially close enough to the center of the fire to reducing the amount of smoke produced by the fire.

Air inlets 42 are defined by bottom wall 40. Inlets 42 are capped with shields 44 that have open ends 46. Shields 44 help to prevent inlets 42 from becoming clogging. Shields 44 also prevent ashes and fire fuel from falling directly out of main body 4. Shields 44 also prevent the cool air from under main body 4 from being pulled directly into the fire. The air is pulled under and along the heated shields 44 so that it is preheated before being used in the combustion.

A cooking grill 50 may be supported directly on rim 8 or on an upright pole 52 that also may support an arm 54 from which one may hang a kettle. Grill 50 can be rotated about pole 52 to remove the cooking surface from above the fire. The handle extends rearwardly from the cooking surface to allow the user to rotate the grill. A winch 56 may be provided to safely change the height of the kettle. Pole 52 may be secured to main body 4. The winch cable is protected inside a tube that has two openings facing downwardly.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A reduced-smoke outdoor fire burning device comprising:
a body having a bottom wall, an inner sidewall, an outer sidewall;
the inner sidewall cooperating with the outer sidewall to define an air supply duct disposed between the inner and outer sidewalls;
the inner and outer sidewalls having lower ends and upper ends; the lower end of the inner sidewall being connected to the bottom wall;
the air supply duct having a lower air inlet disposed between the lower ends of the inner and outer sidewalls;
the inner sidewall defining a plurality of air supply openings disposed adjacent the upper end of the inner sidewall; and
a cap extending between the inner and outer sidewalls at the upper ends of the inner and outer sidewalls.

2. The device of claim 1, wherein the cap extends inwardly from the upper end of the inner sidewall to define a lip disposed above the air supply openings.

3. The device of claim 2, wherein the cap extends outwardly from the upper end of the outer sidewall to define a rim adapted to function as a protective bumper and as a grill tool support shelf.

4. The device of claim 1, further comprising a plurality of feet projecting down from the body to lift the lower air inlet off the ground.

5. The device of claim 1, wherein the bottom wall is substantially circular.

6. The device of claim 5, wherein the inner and outer sidewalls are concentric.

7. The device of claim 6, wherein the inner sidewall has a height and the bottom wall has a diameter; the height of the inner sidewall being about half of the diameter of the bottom wall.

8. The device of claim 7, wherein the bottom wall defines a plurality of air inlets.

9. The device of claim 8, wherein each of the air inlet of the bottom wall is covered by a shield having at least one open end.

10. The device of claim 9, wherein the open end of the shield is spaced from the air inlet.

11. The device of claim 6, wherein the inner sidewall is disposed substantially perpendicular to the bottom wall.

12. The device of claim 1, wherein the air supply openings extend about the entire circumference of the inner sidewall.

13. The device of claim 12, wherein the air supply openings are evenly spaced.

14. The device of claim 1, further comprising a cooking grill disposed above the body.

15. The device of claim 14, further comprising a pole disposed outwardly of the outer sidewall and projecting above the cap; the cooking grill being selectively rotatably carried by the pole in a location spaced above the body; the grill being rotatably carried by the pole so that it can be selectively rotated about the pole to a location where it is not disposed above the body.

16. The device of claim 15, further comprising an arm projecting from the pole; the arm projecting over the body; a winch carried by one of the arm and pole; a winch cable disposed inside the arm.

17. A reduced-smoke outdoor fire burning device comprising:
a body having a circular bottom wall, an inner sidewall, an outer sidewall; the inner and outer sidewalls being concentric;
the inner sidewall cooperating with the outer sidewall to define an air supply duct disposed between the inner and outer sidewalls;
the inner and outer sidewalls having lower ends and upper ends; the lower end of the inner sidewall being connected to the bottom wall;
the air supply duct having a lower air inlet disposed between the lower ends of the inner and outer sidewalls;
the inner sidewall defining a plurality of air supply openings disposed adjacent the upper end of the inner sidewall;
a cap extending between the inner and outer sidewalls at the upper ends of the inner and outer sidewalls; the cap extending inwardly from the upper end of the inner sidewall to define a lip disposed above the air supply openings; and
a plurality of feet projecting down from the body to lift the lower air inlet off the ground.

18. A reduced-smoke outdoor fire burning device comprising:
a body having a circular bottom wall, an inner sidewall, an outer sidewall; the inner and outer sidewalls being concentric; the inner sidewall being substantially perpendicular to the bottom wall;
the bottom wall defining a plurality of air inlets;
each of the air inlets of the bottom wall being covered by a shield having at least one open end; the open end of the shield being spaced from the air inlet;
the inner sidewall cooperating with the outer sidewall to define an air supply duct disposed between the inner and outer sidewalls;
the inner and outer sidewalls having lower ends and upper ends; the lower end of the inner sidewall being connected to the bottom wall;
the air supply duct having a lower air inlet disposed between the lower ends of the inner and outer sidewalls;
the inner sidewall defining a plurality of air supply openings disposed adjacent the upper end of the inner sidewall;
a cap extending between the inner and outer sidewalls at the upper ends of the inner and outer sidewalls; the cap extending inwardly from the upper end of the inner sidewall to define a lip disposed above the air supply openings; and
a plurality of feet projecting down from the body to lift the lower air inlet off the ground.

19. The device of claim 18, wherein the inner sidewall has a height and the bottom wall has a diameter; the height of the inner sidewall being about half of the diameter of the bottom wall.

20. The device of claim 18, wherein the bottom wall has a diameter of about two feet and the inner sidewall has a height of about one foot.
